(19) United States
(12) Patent Application Publication
(10) Pub. No.: US 2020/0033061 A1
(43) Pub. Date: Jan. 30, 2020

(54) COOKING APPLIANCE

(71) Applicant: BSH Hausgeräte GmbH, Munich (DE)

(72) Inventors: Juan Jose Galindo Perez, Zaragoza (ES); Sergio Llorente Gil, Zaragoza (ES); Dan Neumayer, Bernau (DE); Carlos Obon Abadia, Zaragoza (ES); Enrique Javier Perez Visa, Zaragoza (ES)

(21) Appl. No.: 16/466,046

(22) PCT Filed: Dec. 12, 2017
(86) PCT No.: PCT/IB2017/057820

§ 371 Date: Jun. 3, 2019

(30) Foreign Application Priority Data
Dec. 23, 2016 (ES) P201631676

(51) Int. Cl. F27B 5/14; H05B 6/12; H05B 6/44; H05B 6/10

(52) U.S. Cl. CPC F27B 5/14; H05B 6/129; H05B 2206/02; H05B 6/102; H05B 6/44

(57) ABSTRACT

A cooking appliance apparatus includes at least one fan unit having at least one fan wheel which is mounted for rotation about a rotation axis. A heating element is provided to heat the fan wheel in at least one operating state, with the heating element being configured as an induction heating element.

The invention relates to a cooking appliance apparatus according to the preamble of claim 1 and a method for operating a cooking appliance apparatus according to the preamble of claim 11.

A cooking appliance apparatus with a fan unit is already known from the prior art. The fan unit has a fan wheel, which can be rotated about a rotation axis, and generates an air flow by means of the fan wheel in an operating state. The fan unit circulates air present in a cooking chamber by means of the generated air flow. A heating element of the cooking appliance apparatus is arranged on the fan wheel and fastened to the fan wheel in a mounted state. The heating element is attached to the fan wheel in the manner of a coating and is configured as a resistance heating element. Electricity is supplied to the heating element by way of an electrical connecting element, which supplies the heating element with electric current in an operating state.

It is the object of the invention in particular to provide a generic apparatus with improved properties in respect of structure. According to the invention the object is achieved by the features of claims 1 and 11, while advantageous embodiments and developments of the invention will emerge from the subclaims.

The invention is based on a cooking appliance apparatus, in particular an induction cooking appliance apparatus, advantageously an oven apparatus and preferably an induction oven apparatus, with at least one fan unit, which has at least one fan wheel, which can be rotated about a rotation axis, and which generates at least one air flow in particular by means of the fan wheel in at least one operating state, and with at least one heating element, which is provided to heat the fan wheel in at least one operating state.

It is proposed that the heating element is configured as an induction heating element. A “cooking appliance apparatus”, in particular an “induction cooking appliance apparatus”, advantageously an “oven apparatus” and preferably an “induction oven apparatus”, refers in particular to at least a part, in particular a module, of a cooking appliance, in particular an induction cooking appliance, advantageously an oven and preferably an induction oven. In particular the cooking appliance apparatus has at least one muffle, within which at least a part of the fan unit, in particular the fan wheel, and in particular also the heating element and advantageously at least one appliance rear wall, are arranged in at least one mounted state. The muffle in particular delimits at least one cooking appliance interior at least partially and advantageously at least essentially together with at least one cooking appliance door. The muffle in particular delimits at least one cooking chamber at least partially and advantageously at least essentially together with at least one cooking appliance door and/or at least one cooking appliance rear wall. In particular the cooking chamber is arranged within the cooking appliance interior. A “fan unit” refers in particular to a unit with at least one fan wheel, which can be rotated about a rotation axis, which generates an air flow by means of the fan wheel in at least one operating state and circulates and/or sets into motion at least air present in a cooking chamber by means of the air flow. In particular the fan unit sucks air present in a cooking chamber by means of the fan wheel, in particular centrally and advantageously in proximity to the rotation axis, to the fan wheel and then blows the air sucked in away from the fan wheel, in particular at the edge, by means of the fan wheel. For example the fan unit could comprise at least one axial fan. Alternatively or additionally the fan unit could comprise at least one centrifugal fan, which could have in particular a larger heatable surface than an axial fan, thereby allowing a greater transfer of heat and/or a better performance to be achieved. A “rotation axis” refers in particular to an imagined straight line, about which the fan wheel is supported in a rotatable manner and which in particular runs at least essentially parallel to a fan shaft, which drives the fan wheel in a rotatable manner and about which the fan wheel rotates in particular in at least one operating state. “Essentially parallel” here refers in particular to an alignment of a direction relative to a reference direction, in particular in one plane, the direction having a deviation in particular less than 8°, advantageously less than 5° and particularly advantageously less than 2°, from the reference direction. A “fan wheel” refers in particular to an element supported in such a manner that it can be rotated about the rotation axis, which supplies work, in particular in the form of kinetic energy to air present in a cooking chamber in at least one operating state and/or which changes a direction of movement of air present in a cooking chamber in at least one operating state. In particular the fan wheel is made at least largely of at least one magnetic material, in particular at least one ferromagnetic material. The heating element has in particular at least one main function, which is heating the fan wheel. In particular in at least one mounted state the heating element is arranged in at least one position, which is suitable for heating the fan wheel and/or which allows and/or enables optimum heating of the fan wheel. For example in at least one mounted state the heating element could be arranged in proximity to the fan wheel, in particular avoiding direct contact. In particular the heating element could have at least one secondary function, in particular in addition to the main function, it being possible for said secondary function in particular to be heating at least one cooking chamber and/or at least one cooking appliance interior at least partially delimited by a muffle and/or at least one appliance rear wall and/or at least one muffle wall. The cooking appliance apparatus in particular has at least one electrical supply unit, which is provided in particular to supply electrical energy, in particular electric current, to the heating element. In particular the heating element is wound into at least one coil. For example the heating element could have at least two, in particular at least five, advantageously at least ten, particularly advantageously at least fifteen and preferably at least twenty, windings. The heating element in particular has at least one electrical conductor, which is wound in particular into a coil and in particular forms the windings of the heating element. The supply unit supplies the heating element with electrical energy in particular in at least one operating state. In at least one operating state the heating element generates in particular at least one electromagnetic alternating field. In particular the heating element generates Foucault's currents, in particular by means of the electromagnetic alternating field, in at least one, at least largely ferromagnetic, element, for example the fan wheel and/or at least one cooking appliance rear wall and/or at least one muffle wall. In at least one operating state the Foucault's currents generated by the heating element in the at least largely ferromagnetic element in particular result in the heating of the element due to at least one electrical resistance of the element. The element heated by the heating element in particular emits the heat to ambient air in at least one operating state. For example the fan wheel and/or at least one cooking appliance rear wall and/or at least one muffle wall could emit the heat to air sucked out of a cooking chamber in at least one operating state. In particular the fan wheel could blow the air sucked out of the cooking chamber back into the cooking chamber at least essentially simultaneously. There is then no need in particular for a resistance heating element, which reaches very high temperatures to heat air, as the fan wheel itself in particular becomes a heater, in particular a resistance heater, and heat is generated in particular in a surface of the fan wheel. Alternatively or additionally the at least largely ferromagnetic element could be heated in particular by means of remagnetization effects and/or remagnetization losses. “Provided” means in particular specifically programmed, designed and/or equipped. That an object is provided for a specific function means in particular that the object satisfies and/or performs said specific function in at least one application and/or operating state.

The inventive embodiment in particular allows structure to be improved. There is no need in particular for an electrical connection to a heating element present on the fan wheel, thereby simplifying structure and/or avoiding problems in respect of electrical cabling. Compared with a resistance heating element, a larger output is possible, in particular due to a larger heatable surface for transferring heat, in particular with a small temperature load on materials of the objects involved. It is possible in particular to avoid overheating and/or premature failure of the heating element. In particular the heating element can be operated in particular independently of operation of the fan and/or a durable embodiment can be provided.

It is further proposed that the heating element has at least one electrical conductor, which is configured as at least essentially rigid. In particular the conductor is made at least largely of at least one rigid material. For example the conductor could be made at least largely of copper. The conductor is advantageously made at least largely of iron and/or steel, thereby allowing in particular a low-cost and/or economically viable embodiment to be achieved. “Rigid” means in particular unmovable and/or stiff. In particular a distance between adjacent windings of the conductor relative to one another changes by maximum 1 mm, in particular maximum 0.1 mm, advantageously maximum 0.01 mm and preferably maximum 0.001 mm, further to the action of a force of at least 10 N, in particular at least 20 N, advantageously at least 50 N and preferably at least 100 N, on at least one of the adjacent windings. In at least one operating state electric current and advantageously an in particular high-frequency electric alternating current flows through the electrical conductor. This allows particularly good stability to be achieved in particular. There is no need in particular for a coil support, thereby reducing cost and/or allowing the conductor to be positioned flexibly in particular, as advantageously heated air flows can pass the conductor unimpeded.

It is also proposed that the conductor is at least partially wound at least essentially concentrically about the rotation axis. For example a portion in a range from 10% to 50%, in particular 20% to 40% and advantageously 25% to 35%, of a longitudinal extension of the conductor could be wound about the rotation axis. In particular a portion of at least 60%, in particular at least 70%, advantageously at least 80% and preferably at least 90%, of a longitudinal extension of the conductor is wound about the rotation axis. The supply unit is provided in particular to supply electricity to the heating element and in particular supplies the electrical conductor with electric current in at least one operating state. The cooking appliance apparatus in particular has at least one heating element connection, which connects the conductor and supply unit to one another in at least one mounted state. For example the heating element connection and the electrical conductor could be connected to one another at least essentially as a single piece. The heating element connection and the electrical conductor could in particular be formed from the same material. In particular the heating element connection has a longitudinal extension, which is different from a longitudinal extension of the conductor. A “longitudinal extension” of an object refers in particular to an extension of the object in an unwound state along a longitudinal extension direction of the object. A “longitudinal extension direction” of an object refers in particular to a direction aligned parallel to a longest side of a smallest imagined geometric cuboid, which still encloses the object completely when the object is unwound in one plane. An “extension” of an object refers in particular to a maximum distance between two points of a perpendicular projection of the object onto a plane. This allows regular heating of the fan wheel in particular.

It is further proposed that the conductor at least essentially at least partially encloses at least one partial region of the fan wheel at least when viewed along at least one direction perpendicular to the rotation axis. When viewed in the direction perpendicular to the rotation axis the conductor encloses the partial region of the fan wheel over an angle range of at least 180°, in particular at least 270°, advantageously at least 330° and preferably at least 350°, in relation to at least one geometric center of gravity and/or center point of the partial region. In particular at least one winding of the conductor has at least one first partial region and at least one second partial region, which are at a distance from one another in at least one axial direction, which is aligned in particular at least essentially parallel to the rotation axis. In particular at least one winding of the conductor has at least one first partial region and at least one second partial region, which are at a distance from one another in at least one vertical direction, which is aligned in particular at least essentially perpendicular to the rotation axis and in particular at least essentially perpendicular to a main extension plane of a muffle base. The expression “essentially perpendicular” here in particular defines an alignment of a direction relative to a reference direction, the direction and reference direction being at an angle of 90°, in particular when viewed in one plane, and the angle having a maximum deviation of in particular less than 8°, advantageously less than 5° and particularly advantageously less than 2°. A “main extension plane” of an object refers in particular to a plane, which is parallel to a largest side face of a smallest imagined geometric cuboid, which still encloses the object completely, and runs in particular through the center point of the cuboid. This in particular allows surfaces of the partial region opposite one another in a direction parallel to the rotation axis to be heated in a regular manner, thereby avoiding in particular thermal stresses within the partial region.

The conductor could be wound for example into a flat coil. For example windings of the conductor could be arranged in an, in particular single, plane. Windings of the conductor are preferably arranged in at least two, in particular in at least three, advantageously in at least four and preferably in at least five, different planes. Alternatively or additionally windings of the conductor could also be arranged for example in at least eight, in particular in at least ten, advantageously in at least fifteen and preferably in at least twenty, different planes. This allows a high level of flexibility and/or a high level of configuration freedom in particular to be achieved.

The different planes are in particular arranged at least essentially parallel to one another. For example the planes could be aligned at least essentially parallel to a muffle side wall and/or a muffle base. The different planes are preferably aligned at least essentially parallel to a muffle rear wall. In particular at least two windings of the conductor are at a distance from one another in at least one axial direction, which is aligned in particular at least essentially parallel to the rotation axis. In particular at least two windings of the conductor are arranged at a distance from one another in at least one radial direction, which is aligned in particular at least essentially perpendicular to the rotation axis. This allows a compact embodiment and/or deep insertion into the muffle compared with an embodiment, in which the different planes are aligned at least essentially perpendicular to a muffle rear wall.

It is also proposed that the conductor has a stepped configuration when viewed in a cross-sectional plane, which includes the rotation axis and is aligned in particular perpendicular to a muffle rear wall. When viewed in the cross-sectional plane there are in particular at least one first straight line, which connects at least two adjacent windings, and at least one second straight line, which connects at least two adjacent windings, which are different from the windings connected by the first straight line, and which is aligned in particular at least essentially perpendicular to the first straight line. This allows the fan wheel to be heated in particular from a number of sides and/or to be arranged at least partially within the conductor, allowing in particular particularly regular heating of the fan wheel.

It is further proposed that the cooking appliance apparatus has at least one cooking appliance rear wall, the heating element also being provided to heat the cooking appliance rear wall in the operating state. A “cooking appliance rear wall” refers in particular to a unit, which at least partially delimits a cooking chamber in at least one mounted state and which in particular has a main extension plane, which is aligned at least essentially parallel to a main extension plane of a muffle rear wall. In the operating state the heating element is provided in particular to heat the cooking appliance rear wall and the fan wheel at least essentially simultaneously and advantageously by means of the same electromagnetic alternating field. In particular the cooking appliance rear wall is made at least largely of at least one magnetic material, in particular at least one ferromagnetic material. In an alternative embodiment the cooking appliance rear wall could be made at least largely of at least one non-ferromagnetic material, thereby at least essentially preventing the cooking appliance rear wall being heated by the heating element. This in particular allows an electromagnetic alternating field generated by the heating element to be utilized optimally and/or allows particularly efficient and/or fast heating of a cooking chamber.

For example the heating element and fan wheel could be arranged at least essentially within a cooking chamber and/or in front of the cooking appliance rear wall when viewed from a front face. The heating element and fan wheel are preferably arranged behind the cooking appliance rear wall and in particular between the cooking appliance rear wall and a muffle rear wall, which in particular delimits a cooking appliance interior, when viewed from a front face. This in particular allows a well-protected arrangement of the heating element and fan wheel to be achieved. The efficiency of the heating element and fan unit system is in particular non-critical, as any conduction losses and/or heat emission, which can result in particular during operation of the heating element, take place within a cooking appliance interior and can therefore be used in particular to heat the cooking chamber.

A particularly high level of operating convenience can be provided in particular by a cooking appliance, in particular by an induction cooking appliance, advantageously by an oven and preferably by an induction oven, with at least one inventive cooking appliance apparatus, in particular with at least one inventive induction cooking appliance apparatus, advantageously with at least one inventive oven apparatus and preferably with at least one inventive induction oven apparatus.

Operating convenience can in particular be further enhanced by a method for operating an inventive cooking appliance apparatus, in particular an inventive induction cooking appliance apparatus, advantageously an inventive oven apparatus and preferably an inventive induction oven apparatus, with at least one fan unit, which has at least one fan wheel, which can be rotated about a rotation axis, and which generates at least one air flow by means of the fan wheel in particular in at least one operating state. It is proposed that the fan wheel is heated inductively in at least one operating state.

The cooking appliance apparatus here is not limited to the application and embodiment described above. In particular the cooking appliance apparatus can have a number of individual elements, components and units that is different from a number cited herein to bring about a mode of operation described herein.

Further advantages will emerge from the description of the drawings which follows. The drawing shows three exemplary embodiments of the invention. The drawing, description and claims contain numerous features in combination. The person skilled in the art will expediently also consider the features individually and combine them in further useful combinations.

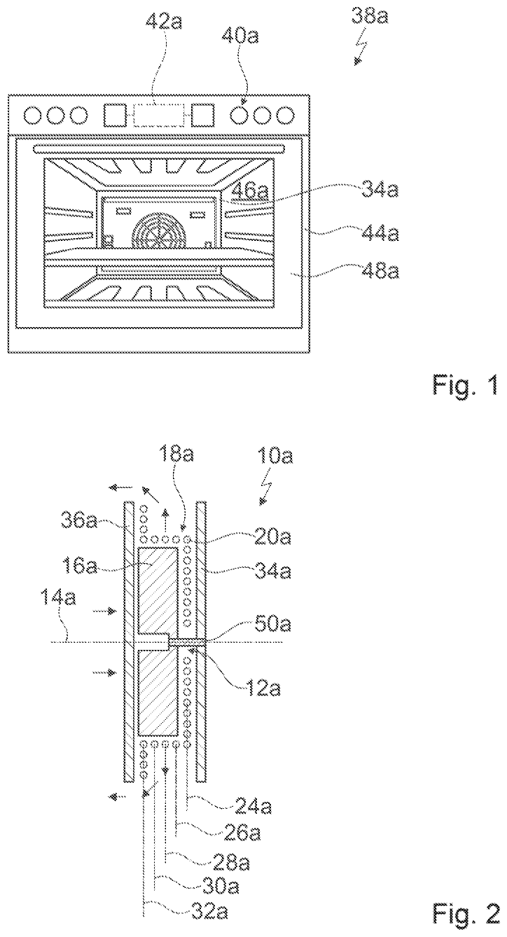

FIG. 1 shows a schematic view of a cooking appliance with a cooking appliance apparatus,

FIG. 2 shows a schematic sectional view of a fan unit, a heating element, a cooking appliance rear wall and a muffle rear wall of the cooking appliance apparatus,

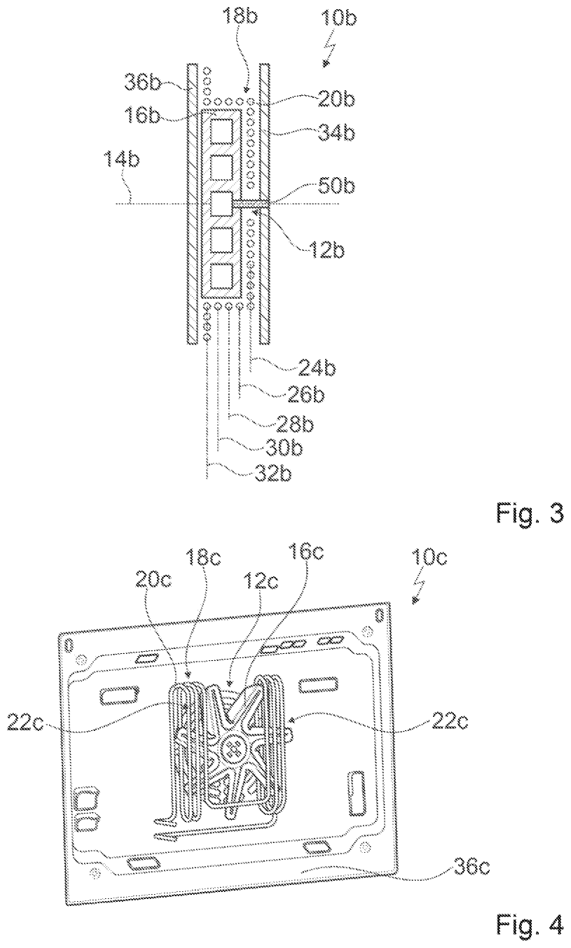

FIG. 3 shows a schematic sectional view of a fan unit, a heating element, a cooking appliance rear wall and a muffle rear wall of an alternative cooking appliance apparatus, and

FIG. 4 shows a schematic view of a fan unit, a heating element and a cooking appliance rear wall of an alternative cooking appliance apparatus.

FIG. 1 shows a cooking appliance 38a with a cooking appliance apparatus 10a. The cooking appliance could be configured as a grill appliance and/or a microwave appliance for example. In the present exemplary embodiment the cooking appliance 38a is configured as an oven.

The cooking appliance apparatus 10a has a muffle 44a. The muffle 44a partially delimits a cooking appliance interior 46a. The muffle 44a essentially delimits the cooking appliance interior 46a together with a cooking appliance door 48a. The cooking appliance apparatus 10a comprises the cooking appliance door 48a.

The muffle 44a has a muffle base, a muffle top, two muffle side walls and a muffle rear wall 34a. The muffle base, the muffle top, the muffle side walls and the muffle rear wall 34a, together with the cooking appliance door 48a, essentially define the cooking appliance interior 46a.

The cooking appliance apparatus 10a has a fan unit 12a (see FIG. 2). The fan unit 12a has a fan wheel 16a, which can be rotated about a rotation axis 14a. The fan unit 12a generates an air flow by means of the fan wheel 16a in an operating state.

When viewed from a front face the fan unit 12a is arranged in a rear region of the cooking appliance interior 46a. The fan unit 12a is arranged in proximity to the muffle rear wall 34a.

The fan unit 12a has a fan shaft 50a. The fan shaft 50a couples the fan wheel 16a to the muffle rear wall 34a. The fan shaft 50a supports the fan wheel 16a in such a manner that it can be rotated relative to the muffle rear wall 34a. The rotation axis 14a runs essentially centrally through the fan shaft 50a. The fan shaft 50a essentially defines the rotation axis 14a.

The cooking appliance apparatus 10a has an operator interface 40a for inputting and/or selecting operating parameters, for example a heating power and/or a heating power density and/or a heating zone. The operator interface 40a is provided to output a value of an operating parameter to an operator.

The cooking appliance apparatus 10a has a control unit 42a. The control unit 42a is provided to perform actions and/or change settings as a function of operating parameters input by means of the operator interface 40a. In a heating operating state the control unit 42a regulates an energy supply to at least one heating element 18a (see FIG. 2).

The cooking appliance apparatus 10a has a heating element 18a. For example the cooking appliance apparatus could have at least one further heating element and in particular at least two, advantageously at least three, particularly advantageously at least five and preferably a number of, further heating elements, in particular in addition to the heating element. Only one of the further heating elements is described below. The further heating element could be provided for example to generate top heat and/or bottom heat and could be arranged in particular in proximity to a muffle top and/or a muffle base.

In the operating state the heating element 18a is provided to heat the fan wheel 16a. In the operating state the heating element 18a heats the fan wheel 16a. The heating element 18a is arranged in proximity to the fan wheel 16a.

In a method for operating the cooking appliance apparatus 10a the fan wheel 16a is heated inductively in the operating state. In the operating state the heating element 18a heats the fan wheel 16a inductively. The heating element 18a is configured as an induction heating element.

The heating element 18a has an electrical conductor 20a (see FIG. 2). The conductor 20a is configured as essentially rigid. The conductor 20a is wound into a coil. In the present exemplary embodiment the conductor 20a is partially wound essentially concentrically about the rotation axis 14a.

Windings of the conductor 20a are arranged in different planes 24a, 26a, 28a, 30a, 32a. In the present exemplary embodiment windings of the conductor 20a are arranged in five different planes 24a, 26a, 28a, 30a, 32a. The planes 24a, 26a, 28a, 30a, 32a, in which windings of the conductor 20a are arranged, are aligned essentially perpendicular to the rotation axis 14a. The planes 24a, 26a, 28a, 30a, 32a, in which windings of the conductor 20a are arranged, are arranged essentially parallel to the muffle rear wall 34a.

When viewed in a cross-sectional plane, which includes the rotation axis 14a, the conductor 20a has a stepped configuration. The conductor 20a has a stepped configuration from the rotation axis 14a in the cross-sectional plane. In the cross-sectional plane the conductor 20a is arranged essentially with mirror symmetry in relation to the rotation axis 14a. The stepped configuration of the conductor 20a allows it to form a holding region for holding the fan wheel 16a.

The heating element 18a heats the fan wheel 16a from a side region of the fan wheel 16a over essentially the entire circumference of the fan wheel 16a in the operating state. In the operating state the heating element 18a heats the fan wheel 16a from a rear face of the fan wheel 16a. In the operating state the heating element 18a also heats a cooking appliance rear wall 36a. In the operating state the heating element 18a is also provided to heat the cooking appliance rear wall 36a.

The cooking appliance apparatus 10a comprises the cooking appliance rear wall 36a. The cooking appliance rear wall 36a is arranged within the cooking appliance interior 46a. The cooking appliance rear wall 36 partially delimits a cooking chamber. The cooking appliance rear wall 36a, together with the muffle top, the muffle base, the muffle side walls and the cooking appliance door 48a, essentially delimits the cooking chamber. The cooking appliance rear wall 36a is arranged in front of the muffle rear wall 34a when viewed from a front face.

The heating element 18a and the fan wheel 16a are arranged behind the cooking appliance rear wall 36a when viewed from a front face. The heating element 18a and the fan wheel 16a are arranged between the cooking appliance rear wall 36a and the muffle rear wall 34a when viewed from a front face. In the present exemplary embodiment the fan wheel 16a is configured as an axial fan.

FIGS. 3 and 4 show two further exemplary embodiments of the invention. The descriptions which follow are limited essentially to the differences between the exemplary embodiments, it being possible to refer to the description of the exemplary embodiment in FIGS. 1 and 2 for components, features and functions that remain the same. To distinguish between the exemplary embodiments, the letter a in the reference characters of the exemplary embodiment in FIGS. 1 and 2 has been replaced by the letters b and c in the reference characters of the exemplary embodiments in FIGS. 3 and 4. It is possible in principle also to refer to the drawings and/or description of the exemplary embodiment in FIGS. 1 and 2 for components of identical designation, in particular for components with identical reference characters.

FIG. 3 shows a fan unit 12b, a heating element 18b, a cooking appliance rear wall 36b and a muffle rear wall 34b of an alternative cooking appliance apparatus 10b. The fan unit 12b has a fan wheel 16b, which can be rotated about a rotation axis 14b. In the present exemplary embodiment the fan wheel 16b is configured as a radial fan.

FIG. 4 shows a fan unit 12c, a heating element 18c and a cooking appliance rear wall 36c of an alternative cooking appliance apparatus 10c. The fan unit 12c has a fan wheel 16c, which can be rotated about a rotation axis 14c. The heating element 18c is provided to heat the fan wheel 16c in an operating state.

The heating element 18c has an electrical conductor 20c (see FIG. 2). The conductor 20c is configured as essentially rigid. The conductor 20c is wound into a coil. In the present exemplary embodiment the conductor 20c essentially partially encloses partial regions 22c of the fan wheel 16c when viewed along a direction perpendicular to the rotation axis 14c.

### REFERENCE CHARACTERS

10 Cooking appliance apparatus
12 Fan unit
14 Rotation axis
16 Fan wheel
18 Heating element
20 Conductor
22 Partial region
24 Plane
26 Plane
28 Plane
30 Plane
32 Plane
34 Muffle rear wall
36 Cooking appliance rear wall
38 Cooking appliance
40 Operator interface
42 Control unit
44 Muffle
46 Cooking appliance interior
48 Cooking appliance door
50 Fan shaft

1-11. (canceled)

12. A cooking appliance apparatus, comprising:
a fan unit including a fan wheel mounted for rotation about a rotation axis; and
a heating element configured to heat the fan wheel in an operating state, said heating element being configured as an induction heating element.

13. The cooking appliance apparatus of claim 12, wherein the heating element has an electrical conductor, which is configured substantially rigid.

14. The cooking appliance apparatus of claim 13, wherein the conductor is at least partially wound at least essentially concentrically about the rotation axis.

15. The cooking appliance apparatus of claim 13, wherein the conductor at least partially encloses a partial region of the fan wheel when viewed along a direction perpendicular to the rotation axis.

16. The cooking appliance apparatus of claim 13, wherein the conductor has windings arranged in at least two different planes.

17. The cooking appliance apparatus of claim 16, further comprising a muffle rear wall, wherein the different planes are aligned at least essentially parallel to the muffle rear wall.

18. The cooking appliance apparatus of claim 13, wherein the conductor has a stepped configuration when viewed in a cross-sectional plane, which includes the rotation axis.

19. The cooking appliance apparatus of claim 12, further comprising a cooking appliance rear wall, said heating element configured to heat the cooking appliance rear wall in the operating state.

20. The cooking appliance apparatus of claim 19, wherein the heating element and the fan wheel are arranged behind the cooking appliance rear wall when viewed from a front face.

21. A cooking appliance, comprising a cooking appliance apparatus, said cooking appliance apparatus comprising a fan unit including a fan wheel mounted for rotation about a rotation axis, and a heating element configured to heat the fan wheel in an operating state, said heating element being configured as an induction heating element.

22. The cooking appliance of claim 21, wherein the heating element has an electrical conductor, which is configured substantially rigid.

23. The cooking appliance of claim 22, wherein the conductor is at least partially wound at least essentially concentrically about the rotation axis.

24. The cooking appliance of claim 22, wherein the conductor at least partially encloses a partial region of the fan wheel when viewed along a direction perpendicular to the rotation axis.

25. The cooking appliance of claim 22, wherein the conductor has windings arranged in at least two different planes.

26. The cooking appliance of claim 25, wherein the cooking appliance apparatus includes a muffle rear wall, wherein the different planes are aligned at least essentially parallel to the muffle rear wall.

27. The cooking appliance of claim 22, wherein the conductor has a stepped configuration when viewed in a cross-sectional plane, which includes the rotation axis.

28. The cooking appliance of claim 21, wherein the cooking appliance apparatus includes a cooking appliance rear wall, said heating element configured to heat the cooking appliance rear wall in the operating state.

29. The cooking appliance of claim 28, wherein the heating element and the fan wheel are arranged behind the cooking appliance rear wall when viewed from a front face.

30. A method for operating a cooking appliance apparatus, comprising heating a rotatable fan unit of the cooking appliance apparatus inductively in an operating state.
